(19) United States
(12) Patent Application Publication
(10) Pub. No.: US 2016/0283896 A1
(43) Pub. Date: Sep. 29, 2016

(54) OPERATING AN INVENTORY SYSTEM OF A VEHICLE

(71) Applicant: GM GLOBAL TECHNOLOGY OPERATIONS LLC, Detroit, MI (US)

(72) Inventor: Robert A. Dziurda, Clinton Township, MI (US)

(21) Appl. No.: 14/667,243

(22) Filed: Mar. 24, 2015

(51) Int. Cl. G06Q 10/08; G06K 19/077

(52) U.S. Cl. CPC G06Q 10/087; G06K 19/07758

(57) ABSTRACT

A method of operating an inventory system of vehicle. The method may be used to provide notifications that an article is either present at or absent from the vehicle. The method may comprise detecting the existence of one or more conditions associated with initiating operation of the vehicle, accessing a list of articles expected to be present at the vehicle when the detected condition(s) exist, determining whether articles on the accessed list are not present at the vehicle, and when it is determined that an article is not present at the vehicle, causing a notification indicating the absence of the article(s) to be generated. The method may additionally or alternatively comprise detecting that an occupant has exited the vehicle, determining that an article is present at the vehicle, and causing a notification indicating the presence of the article to be generated.

### TECHNICAL FIELD

The present invention relates generally to an inventory system of a vehicle and, more particularly, to operating such a system to provide notifications that a particular article is either present at or absent from a vehicle based on the receipt (or lack of receipt) of electrical signals from an electronic tag associated with that article.

### BACKGROUND

It is not uncommon for a person traveling in a vehicle from an origination point to a destination point to have inadvertently forgotten or left behind an article that may be needed when the person arrives at the destination point. For example, it is not uncommon for a person to have left behind one or more of a wallet, cellular telephone, laptop computer, sunglasses, briefcase, and/or diaper bag, to cite only few examples. It is similarly not uncommon for a person who exited a vehicle to have unwittingly left an article in the vehicle that may be needed while the person is away from the vehicle. In both instances, the driver of the vehicle may become distracted searching for the missing/forgotten article, and the forgotten article may have to be retrieved, thereby resulting in frustration, a loss of time on the part of the person having to retrieve the article, and/or other adverse consequences.

In view of the foregoing, it may be beneficial for a system of a vehicle to be able to determine that certain articles are present at the vehicle, and/or that certain articles are not present at (i.e., are absent from) the vehicle, and to provide notifications relating to such in-vehicle inventory of articles.

### SUMMARY

According to one embodiment, there is provided a method of operating an inventory system of a vehicle having an electronic control unit (ECU), a wireless receiver, and one or more electronic tags. The method comprises detecting the existence of one or more predetermined conditions associated with initiating the operation of the vehicle, and automatically accessing a list of articles expected to be present at the vehicle when the detected condition(s) exist, wherein in an embodiment, the list of articles is selected from a plurality of pre-established lists of articles based on the detected condition(s). The method further comprises receiving an electrical signal from each electronic tag associated with an article that is present at the vehicle, and determining whether any of the articles on the accessed list are not present at the vehicle based on the electrical signal(s) received from the electronic tag(s). When it is determined that one or more articles are not present at the vehicle, the method still further comprises causing a notification to be generated that is indicative of the absence of that or those articles.

According to another embodiment, there is provided a method of operating an inventory system of a vehicle having an electronic control unit (ECU), a wireless receiver, and one or more electronic tags. The method comprises detecting that an occupant has exited the vehicle, determining that an article is present at the vehicle in response to the receipt of an electrical signal from an electronic tag associated with that article, and causing a notification to be generated that is indicative of the presence of the article at the vehicle.

According to yet another embodiment, there is provided a method of operating an inventory system of a vehicle comprised of an electronic control unit (ECU), a wireless receiver, and one or more electronic tags. The method comprises receiving from an electronic tag associated with an article present at the vehicle, an electrical signal representative of an identifier unique to that particular tag, and determining whether the received identifier has been correlated in an electronic memory device with a particular article. When it is determined that the received identifier has not been correlated with an article, the method further comprises prompting a user to correlate the received identifier with an article. The method still further comprises receiving one or more electrical signals representative of a representation of an article with which the received identifier is to be correlated, and storing the identifier and the representation of the article correlated therewith in the electronic memory device.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic and block diagram view of a vehicle;

FIG. 2 is a schematic and block diagram view of an illustrative embodiment of an inventory system of a vehicle such as that illustrated in FIG. 1;

FIG. 3 is a flow diagram of an illustrative embodiment of a method of operating a vehicle inventory system, such as, for example, that illustrated in FIG. 2;

FIGS. 4a and 4b are diagrammatic views of user interfaces that may be used to perform certain steps of the method illustrated in FIG. 3;

FIG. 5 is a diagrammatic view of a look-up table used in the performance of certain steps of the method illustrated in FIG. 3; and

FIG. 6 is a flow diagram showing additional steps that may be included in the method illustrated in FIG. 3; and

FIG. 7 is a flow diagram of another illustrative embodiment of a method of operating a vehicle inventory system, such as, for example, that illustrated in FIG. 2.

### DETAILED DESCRIPTION OF THE EMBODIMENTS

The method and system described below may be used to provide notifications relating to an inventory of articles within a vehicle. This may include, for example, providing a notification that an article has been left in the vehicle after a vehicle occupant has exited the vehicle, or that an article is not present at (is absent from) the vehicle at, for example, the outset of the operation of the vehicle. More particularly, in an embodiment, the method and system may detect the existence of one or more predetermined conditions associated with initiating operation of the vehicle, automatically access a list of articles expected to be present at the vehicle when the detected condition(s) exist, determine whether any articles on the accessed list are not present at the vehicle based at least in part on electrical signal(s) received from electronic tag(s) associated with corresponding article(s) present at the vehicle, and when it is determined that an article is not present at the vehicle, cause a notification to be generated that is indicative of the absence of the article(s). In another embodiment, the method and system may detect that an occupant has exited the vehicle, determine that an article is present at the vehicle in response to the receipt of an electrical signal from an electronic tag associated with that article, and cause a notification to be generated that is indicative of the presence of the article.

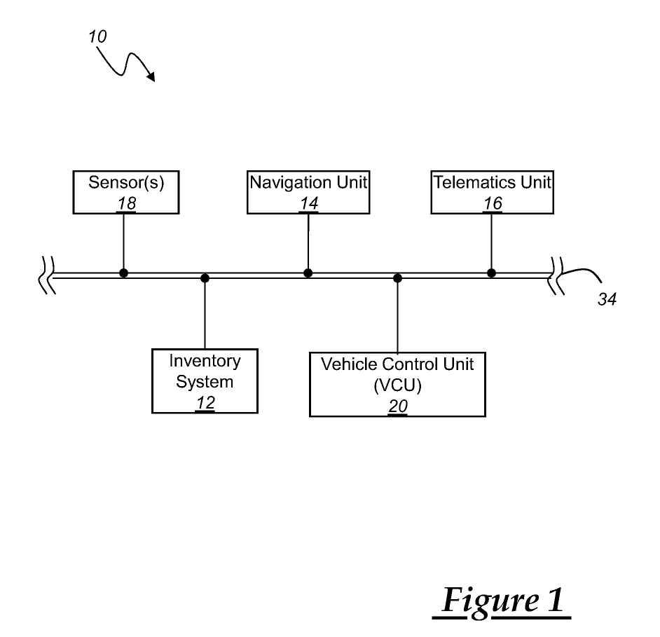

With reference to FIG. 1, there is shown a schematic representation of some of the components of a vehicle 10 with which the present system and method may be used or implemented. It should be appreciated that the vehicle 10 may comprise any type of vehicle, including traditional passage vehicles, sports utility vehicles (SUVs), cross-over vehicles, trucks, vans, buses, recreational vehicles (RVs), motorcycles, etc. These are merely some of the possible applications as the system and method described herein are not limited to any particular type(s) of vehicles, but rather may be implemented or used with any number of different vehicles. According to an embodiment, the vehicle 10 generally includes an inventory system 12, a navigation system 14, a telematics unit 16, one or more sensors 18, and a vehicle control unit (VCU) 20, among possibly other components, systems, and/or devices that may or may not be illustrated or otherwise described herein.

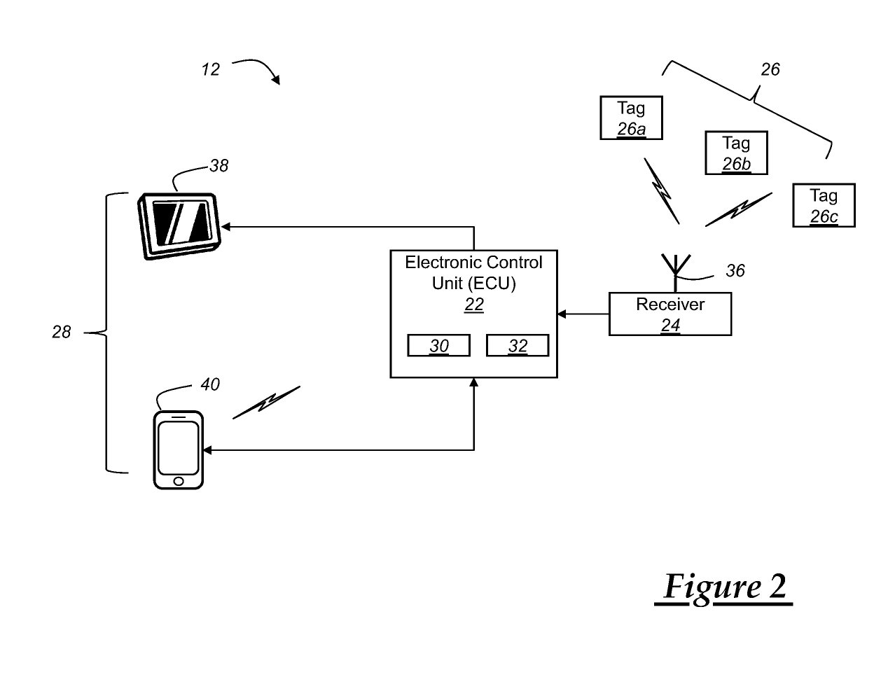

In an embodiment, the inventory system 12 is configured to detect or determine whether one or more articles are present at or absent from the vehicle 10, and in response, to provide notifications indicative of that determination. With respect to FIG. 2, in an illustrative embodiment, the inventory system 12 comprises a vehicle control module that may include an electronic control unit (ECU) 22, a wireless receiver 24, one or more electronic tags 26 (each of which is associated with a respective article), and one or more user interface devices 28, among possibly other components and/or devices.

The ECU 22 may include any variety of electronic processing devices, memory devices, input/output (I/O) devices, and/or other known components, and may perform various functions including, among potentially others, one or more of the functions of the present method described below. In an illustrative embodiment, the ECU 22 comprises an electronic memory device 30 and an electronic processing device 32. The electronic memory device 30 is configured to store various information, instructions, software, algorithms, data, etc. to be used in the operation of the inventory system 12, including in the performance of some or all of the steps of the method described below. The electronic processing device 32, which may comprise, for example, and without limitation, a microprocessor, a microcontroller, an application specific integrated circuit (ASIC), etc., is configured to execute instructions for software, firmware, programs, algorithms, scripts, etc. that are stored in memory device 30, and may at least partially govern the processes and methods described herein.

The ECU 22 may also be electrically connected to other vehicle devices, modules, systems, and components, and may be configured to interact with that or those components when or as required. The ECU 22 may be directly coupled to one or more of these components/devices/systems, indirectly coupled via other electronic devices, a vehicle communications bus (e.g., bus 34 shown in FIG. 1), network, etc., or coupled according to some other arrangement known in the art. Depending on the particular implementation, the ECU 22 may be a standalone ECU, may be incorporated or included within another vehicle control module (e.g., the telematics unit 16, the VCU 20, an infotainment system, a body control module, etc.) such that the functionality thereof is integrated or incorporated into an ECU or other electronic processing device of another component, or may be part of a larger network or system of vehicle 10, to name a few possibilities. Accordingly, the ECU 22 is not limited to any one particular embodiment or arrangement; rather any suitable embodiment or arrangement may be used.

The wireless receiver 24 is electrically connected to the ECU 22, and, in an embodiment, the processing device 32 thereof, in particular. The receiver 24 is configured to receive electrical signals transmitted by the electronic tag(s) 26, and to then pass the received signals, or at least the information represented thereby, to the ECU 22. While in some embodiments the receiver 24 is configured to only receive electrical signals, in other embodiments the receiver 24 may also be configured to transmit electrical signals. In the latter instance, the receiver 24 comprises a transceiver rather than simply a receiver. In any event, the receiver 24 may comprise any suitable receiver (or transceiver) known in the art that is capable of receiving or receiving and transmitting electrical signals, for example, radio frequency (RF) signals. To that end, the receiver 24 may include an antenna 36 (shown in FIG. 2) and other components required for receiving or receiving and transmitting electrical signals in the manner required for operating the inventory system 12. For purposes of illustration, the receiver 24 may comprise a receiver/transceiver such as that or those used in keyless vehicle entry systems. In such systems electrical signals transmitted by a key fob are received by a receiver located at the vehicle, and are then used to control the operation of the door locks of the vehicle, the remote starting of the vehicle, etc. In any event, it will be appreciated that any suitable type of receiver/transceiver may be used as the present system and method are not limited to any particular type of receiver/transceiver.

As briefly described above, the inventory system 12 may include one or more electronic tags 26, each one of which may be associated with a respective article. This may include, for example, attaching or affixing the tag 26 to the corresponding article (e.g., via a clip, adhesive, etc. on the tag 26, article, or both), or otherwise associating the tag 26 with the corresponding article without attaching or affixing it to the article (e.g., placing the tag in a bag, briefcase, pocket, wallet, etc.). For purposes of illustration, the description below will be with respect to an embodiment wherein the system 12 includes a plurality of tags 26 (e.g., tags 26a, 26b, and 26c shown in FIG. 2). It will be appreciated, however, that in other embodiments, system 12 may include a single tag 26, and therefore, the present system and method are not limited to the use of any particular number of tags.

The tags 26 may comprise a number of different types of tags, dependent, of course, on the particular implementation of the system 12. For example, and without limitation, the tags 26 may comprise radio frequency identification (RFID) tags, near field communication (NFC tags), Bluetooth tags, or any other suitable wireless/electronic identification tags known in the art. Additionally, the tags 26 may be passive tags or active tags. It will therefore be appreciated that the system and method described herein are not limited to any particular type(s) of tags, but rather any suitable tags may be used.

The structure and operation of electronic/identification tags, such as, for example, those identified above, are well known in the art, and therefore, will not be described in detail here. To summarize, however, each tag 26 may include, among other components, an electronic processing device (e.g., a microprocessor, microcontroller, ASIC, etc.), an electronic memory device, a power source, and an antenna. In an embodiment wherein the power source is a rechargeable power source, the tag 26 may also include an induction charging coil antenna and other circuitry or electric components that may be used to facilitate inductive charging.

Each tag 26 is programmed with an identifier unique to that particular tag, which may be stored in the memory device of the tag 26. For a particular tag 26, the identifier may comprise a unique code including one or more alphabetic, numeric, and/or other characters that is assigned to and programmed into the tag 26 during, for example, the manufacture of the tag 26 or the inventory system 12. In operation, each tag 26 is configured to transmit an electrical signal representative of the unique identifier corresponding or assigned thereto. This transmission may be facilitated in response to an inquiry or interrogation by, for example, the ECU 22 or another component of the system 12 (e.g., a separate reader or interrogator), or may alternatively be performed autonomously (i.e., the tag may periodically or continuously transmit without interrogation). In either instance, the electrical signals may be transmitted from the transmitter/transceiver of the tag 26 and may be received by the receiver 24 and the signal(s) and/or the information represented thereby is passed to the ECU 22. The ECU 22 may then use the received signals/identifiers to, for example, pair or sync each of the tags 26 to the ECU 22. Additionally or alternatively, the ECU 22 may use the received identifiers to determine which articles are present at and/or absent from the vehicle 10 based on a tag identifier/article correlation stored in, for example, the memory device 30 of the ECU 22.

More particularly, the identifier of each tag may be correlated with a particular article in a look-up table or other data structure stored in an electronic memory device of the system 12 (e.g., the memory device 30 of the ECU 22). In an embodiment, this correlation is made during manufacture of the system 12 such that each tag 26 is intended to always be associated with the same article. For example, if the system 12 includes two (2) tags 26, the identifier for a first tag 26a may be correlated with a first article (e.g., a cellular telephone) and the identifier of a second tag 26b may be correlated with a second article different than the first article. To ensure that the user associates tags 26a and 26b with the right articles, tag 26a may be labeled with the name or other indicia of the first article, and tag 26by may be labeled with the name or other indicia of the second article. Additionally or alternatively, the identifier/article correlation may be made during the operation of the system 12, and may involve the user making the correlations. For example, and as will be described in greater detail below, when an identifier of a tag 26 that has not been correlated with an article is received by the ECU 22, the ECU 22 may prompt the user to identify the article corresponding to that particular identifier. More specifically, a tag 26 may be marked or labeled with the identifier corresponding thereto or some other non-article-specific representation thereof (e.g., TAG1, TAG2, etc.). When an electrical signal is received from that tag 26, the identifier (or some representation thereof) may be displayed on a user interface device 28. The user may then match the displayed identifier with that labeled or marked on the tag 26 itself, and then provide an input to the system 12 identifying the article with which that tag 26 has been associated, and thus, with which that identifier should be correlated. For example, assume for the sake of illustration only that a tag 26 associated with a cellular telephone is marked as TAG1. Assume further that upon receipt of an electronic signal from that tag, the identifier TAG1 is displayed on a user interface device 28. In an embodiment, the user may be able to select “TAG1” and then provide an input to allow the ECU 22 to correlate the identifier of that tag with “cellular telephone.” Regardless of how the tag identifier/article correlation is carried out, it may be used, as will be described in greater detail below, to determine an inventory of articles present at and/or absent from the vehicle 10.

As briefly described above, the inventory system 12 may further include one or more user interface devices 28. The user interface device(s) 28 may be electrically connected to (e.g., hardwired or wirelessly), and configured for communication with, the ECU 22, and may include any number of devices suitable to display or provide information to, and/or to receive information from, a user. As such, the user interface device(s) 28 may comprise any combination of hardware, software, and/or other components that enable the communication or exchange of information between the system 12 and a user. In an illustrative embodiment, the user interface device(s) 28 may comprise one or more of any number of known user interfaces, such as, for example and without limitation: a liquid crystal display (LCD); a touch screen LCD; a keypad; a keyboard; a microphone; a speaker; and/or a handheld electronic device (e.g., smart phone, tablet, personal digital assistant (PDA), etc.), to cite a few possibilities. As such, it will be appreciated that the system and method are not limited to any particular number or type(s) of user interfaces, but rather any suitable user interface may be used.

In the illustrative embodiment depicted in FIG. 2, the user interface device(s) 28 may comprise a touch screen 38 configured to display one or more graphical or text-based user interfaces. The touch screen 38 may comprise a dedicated, standalone touch screen; or alternatively, may comprise a touch screen that is part of or shared by one or more other components or systems of the vehicle (e.g., navigation system 14, telematics unit 16, an infotainment system, etc.). In either instance, the touch screen 38 may be disposed within the dashboard of the vehicle, or in close proximity thereto.

In another embodiment, the user interface device(s) 28 may additionally or alternatively comprise a handheld electronic device 40 (e.g., a smart phone, tablet, etc.) that is configured with a computer application or other software stored thereon that when executed allows the user to interact with the system 12. Those having ordinary skill in the art will appreciate that this interaction or communication may be facilitated across one or more wires connected between the device 40 and the ECU 22 (e.g., through a cable coupled to and between electromechanical ports of or associated with each of the device 40 and ECU 22) or wirelessly over any number of known communication networks or links using any number of known communication protocols. Accordingly, the ECU 22 and the handheld device 40 may each comprise a network interface that includes, or is electronically connected to, certain communication-supporting infrastructure (e.g., one or more known components or devices, such as, for example, routers, modems, antenna, electrical ports, transceivers, etc.) to facilitate the interaction and communication between the user and the system 12. Alternatively, such interaction and communication may be facilitated over by another system or component of the vehicle 10 that may be used in conjunction with the inventory system 12, for example, the telematics unit 16.

In any event, the user interface device(s) 28 may be configured to display graphical and/or text-based user interfaces that allows the system 12 to interact with the user, and in some embodiments, the user to interact with the system 12. For instance, the user interface device(s) 28 may be configured to display a list of articles determined to be present at the vehicle, a list of articles determined to be absent from the vehicle, or both. The user interface device(s) 28 may be additionally or alternatively configured to display user interfaces comprised of user-selectable or user-inputted fields that allow the user to provide information, for example, correlations between one or more tags 26 and one or more corresponding articles, and/or to create, update, or otherwise review lists of articles that are expected to be either present at or absent from the vehicle when certain conditions exist. Accordingly, the user interface device(s) 28 may be used for any number of purposes including purposes not expressly described herein.

In an embodiment, the vehicle 10 may further include a navigation system or unit 14 that provides navigation readings representing the location or position of the vehicle 10 and/or roads in the vicinity of the vehicle 10. In an embodiment, these readings may be provided to the inventory system 12, the telematics unit 16, and/or one or more other components of the vehicle 10 for purposes that will be described in greater detail below. Depending on the particular implementation, the navigation unit 14 may be a standalone vehicle control module or may be integrated within some other component or system of the vehicle (e.g., the inventory system 12, the telematics unit 16, etc.). The navigation unit 14 may include any combination of components, devices, modules, etc., like a GPS unit or a memory device with stored map data, and may use the current position of the vehicle 10 and road- or map-data to evaluate upcoming road segments. It is also possible for the navigation unit 14 to have some type of user interface so that information can be verbally, visually, or otherwise exchanged between the unit and occupant(s) of the vehicle. The navigation unit 14 can store pre-loaded map data and the like, or it can wirelessly receive such information through the telematics unit 16 or some other communications device of the vehicle, to cite a few possibilities. Any suitable navigation unit may be used, as the present system and method are not limited to any particular type.

The telematics unit 16 can be used to provide a diverse range of vehicle services, some of which involve wireless communication to and/or from the vehicle 10. An illustrative example of a telematics unit is that described in U.S. Patent Publication No. 2014/0067152 published on Mar. 6, 2014, the entire contents of which are incorporated herein by reference. To summarize, however, the telematics unit 16 enables wireless voice and/or data communication over a wireless carrier system and via wireless networking. This enables the vehicle to communicate with, for example, a call center, other telematics-enabled vehicles, or some other entity or device (e.g., in an embodiment, the handheld device 40 of the inventory system 12). The telematics unit 16 also enables the vehicle 10 to offer a number of different services including those related to one or more of navigation, telephony, emergency assistance, diagnostics, infotainment, fleet management, etc. In an embodiment, the telematics unit 16 comprises a vehicle control module that includes a standard cellular chipset for voice communications like hands-free calling, a wireless modem for data transmission, an electronic processing device, one or more electronic memory devices, and a dual antenna. The processing device of the telematics unit 16 can be any type of device capable of processing electronic instructions including microprocessors, microcontrollers, host processors, controllers, vehicle communication processors, and ASICs. It can be a dedicated processor used only for the telematics unit 16, or it can be shared with other vehicle systems (e.g., an infotainment system, the inventory system 12, the navigation unit 14, etc.). The processor executes various types of digitally-stored instructions, such as software or firmware programs stored in a memory device that is accessible by the processor, which enable the telematics unit 16 to provide a wide variety of services or perform a number of functions, including, in at least some embodiments wherein some or all of the functionality of the inventory system 12 is integrated into the telematics unit 16, some or all of those functions of the method described below. These services or functions may include, for example: turn-by-turn directions and other navigation-related services provided in conjunction with the navigation unit 14; emergency or roadside assistance-related services; diagnostic reporting using one or more diagnostic modules; infotainment services; and providing or facilitating notifications or alerts relating to articles that are either present at or absent from the vehicle 10 to a call center, one or more other vehicles, and/or another entity. As with the navigation unit 14, any suitable telematics unit may be used, as the present system and method are not limited to any particular type.

Vehicle sensors 18 may comprise any number of different sensors, components, devices, modules, systems, etc., and may provide information or data that may be used to carry out or perform at least some of the steps of the method described below. The sensors 18 may be configured to monitor, sense, detect, measure, or otherwise determine a variety of parameters that may then be used to evaluate whether certain predetermined conditions exist, and/or whether certain predetermined events have occurred. For example, and as will be described more fully below, readings from the sensors 18 may be used to detect, determine, or derive that certain conditions relating to the occupancy of the vehicle exist. Such occupancy-related conditions may include, for example: that the vehicle is either occupied or unoccupied; that an occupant has exited or entered the vehicle 10; that the vehicle 10 is occupied by a particular person; that a particular passenger position (i.e., seat) within the vehicle 10 is occupied; etc. Readings from the sensors 18 may additionally or alternatively be used to detect, determine, or derive that certain conditions relating to the weather in vicinity of the vehicle 10 exist. Such weather-related conditions may include, for example: that it is raining or snowing in the vicinity of the vehicle 10; that the ambient temperature outside the vehicle 10 is above or below a particular threshold; etc. In any event, the sensors 18 may include any number of different sensors, including, but not limited to: ambient temperature sensor(s); atmospheric pressure sensor(s); rain sensor(s); water detection sensor(s); seat occupancy sensor(s); among other suitable sensors known in the art.

The sensors 18 may be embodied in hardware, software, firmware, or some combination thereof. The sensors 18 may directly sense or measure the parameter(s) for which they are provided, or may indirectly evaluate or derive such parameters based on information provided by other sensors, components, devices, etc. The sensors 18 may be directly coupled to one or more of the vehicle components described above (e.g., the inventory system 12, the navigation unit 14, and/or the telematics unit 16), indirectly coupled thereto via other electronic devices (e.g., a bus (bus 34), a network, etc.) or coupled in accordance with some other arrangement known in the art. Some or all of the sensors 18 may be integrated within one or more vehicle components (e.g., one or more of those described above), may be standalone components, or may be provided according to some other arrangement.

As is known in the art, the VCU 20 may be configured to control or facilitate various functions relating to the operation of the vehicle 10 and, in an embodiment, may be configured to exert a measure of control over the operation of one or more of the vehicle components described above. To that end, the VCU 20 may be coupled, either wirelessly or by a hardwired connection (e.g., via bus 34), to one or more of the vehicle components described above so that it can, for example, gather sensor readings from the sensors 18 and, in at least certain embodiments, provide command signals to the inventory system 12, the navigation unit 14, the telematics unit 16, and/or other vehicle components. The VCU 20 may include any variety of electronic processing devices (e.g., a microprocessor, a microcontroller, ASIC), electronic memory devices, input/output (I/O) devices, and/or other known components, and may perform various functions including, among potentially others, one or more of the functions of the present method (e.g., in an embodiment wherein some or all of the functionality of the inventory system 12 is integrated into the VCU 20). Depending on the particular implementation, the VCU 20 may be a standalone module, may be incorporated or included within another vehicle control module, or may be part of a larger network or system of vehicle 10, to name a few possibilities. Accordingly, the VCU 20 is not limited to any one particular embodiment or arrangement, rather any suitable embodiment or arrangement may be used.

It should be appreciated that the foregoing description of the vehicle 10 and the constituent components, systems, devices, etc. thereof has been provided for purposes of example and illustration only, and as such, is not meant to be limiting in nature. Rather vehicle and/or component embodiments or arrangements in addition to or in lieu of that or those described above may certainly be used.

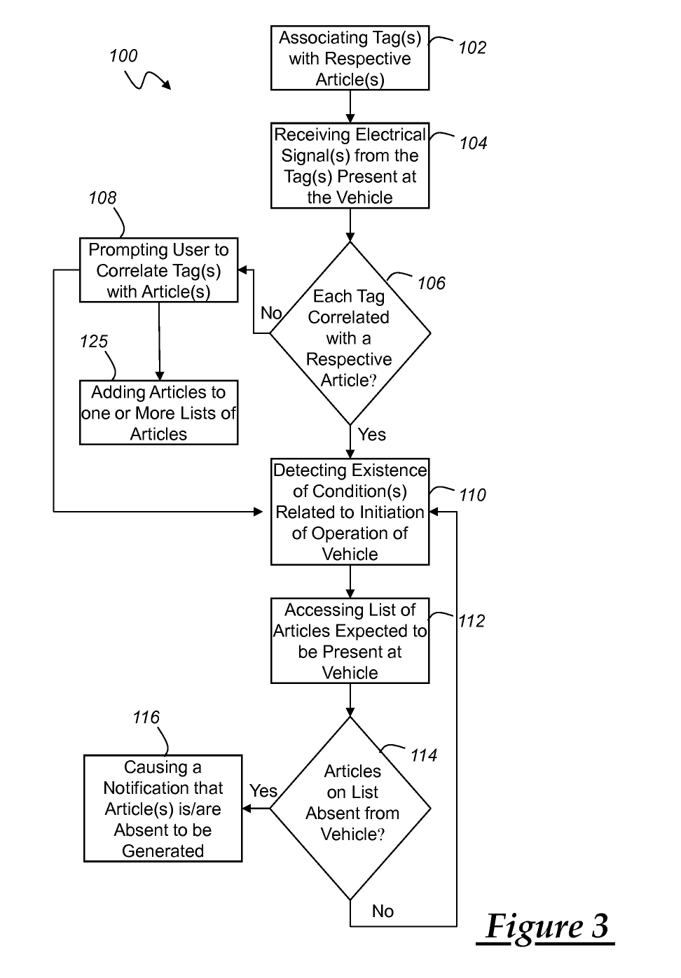

Turning now to FIG. 3, there is shown a method 100 of operating an inventory system of a vehicle that comprises an ECU, a wireless receiver, and one or more electronic tags. For purposes of illustration, the method 100 will be described in the context of the vehicle 10 described above and illustrated in FIG. 1, and the systems, components, devices, etc. thereof in particular (e.g. the inventory system 12, navigation system 14, telematics unit 16, etc.). It will be appreciated, however, that the application of the present methodology is not meant to be limited solely to the arrangement of the vehicle 10 and its constituent components described above, but rather method 100 may find application with any number of vehicles or arrangements (e.g., vehicles or arrangements in which one or more steps of method 100 may be performed by systems or components of the vehicle 10 other than that or those described below, etc.). Additionally, it will be appreciated that unless otherwise noted, the performance of method 100 is not meant to be limited to any one particular order or sequence of steps, or to any particular component(s) for performing the steps.

Method 100 comprises a step 102 of associating each of the tags 26 of the inventory system 12 with a respective article. This may comprise attaching or affixing tag to the corresponding article using, for example, a clip, adhesive, or other known affixation/attachment means disposed on one or both of the article and the tag. In certain embodiments, step 102 may also or alternatively comprise associating a tag with an article without attaching/affixing the tag to the article, but rather by placing the tag inside the article itself or a compartment thereof. For example, a tag may be associated with a briefcase, purse, diaper bag, and other like articles by simply placing the tag inside a compartment or pocket of that article.

Method 100 further comprises a step 104 of receiving one or more electrical signals from each tag 26 that is present at the vehicle 10, wherein signal(s) received from a given tag are representative of the identifier that is unique to that tag. In an embodiment, step 104 may include receiving electrical signals from tags 26 located within the passenger compartment of the vehicle 10 only, or from tags that are either located within the passenger compartment or outside of it but that are nonetheless present at the vehicle 10 (e.g., tags located in the truck, glove compartment, center console, etc.). In at least some embodiments or implementations, the receipt of signals in step 104 may cause the tags from which that or those signals are received to be paired or synched with, for example, the ECU 22 of the system 12. In any event, in an embodiment, the signals are received in step 104 by the receiver 24 of the inventory system 12, which then passes the signals, or at least information represented thereby, to the ECU 22 of the inventory system 12.

In at least some embodiments, method 100 may further include a step 106 of determining whether each tag 26 from which electrical signals were received in step 104 is correlated with particular article in a look-up table or other data structure stored in a memory device of the system 12 (e.g., the memory device 30 of the ECU 22). This may comprise, for example, looking up the unique identifier of each tag from which an electrical signal was received in the look-up table, and then determining whether a correlation exists for each of those identifiers, and therefore, corresponding tags. For example, the unique identifier corresponding to a given tag is looked up in the look-up table, if that identifier is found in the look-up table and the table reflects a correlation between the identifier and an article, then it can be determined that the identifier, and thus the corresponding tag, has, in fact, been correlated with an article. If, however, the unique identifier is either not found in the look-up table or the table does not reflect a correlation for that particular identifier, it can be determined that the identifier, and thus the corresponding tag, has not been correlated with an article. If it is determined in step 106 that all of the tags have been correlated with an article, method 100 may proceed to, for example, step 110 described below. If, however, it is determined in step 106 that one or more of the received identifiers is/are not correlated with an article, method 100 may proceed to a step 108 of prompting a user to correlate that or those tags with an article.

Step 108 may be performed in a number of ways. One illustrative way is by displaying the identifier(s) (or a representation thereof) of the tag(s) for which correlation is required on a user interface device 28 of the system 12, and then prompting the user to assign or correlate that particular identifier with an article (e.g., the article with which the tag is associated). Using one or more user-selectable or user-inputtable fields displayed on a user interface device 28, the user may then input the name or other indicia or representation of the article to be correlated with that identifier, and thus, the tag corresponding thereto. This may include, for example, typing in the name of the article using an actual or virtual keyboard/keypad, selecting an icon representative of the article, selecting the name of the article from a menu (e.g., drop down menu), selecting a radio button corresponding to that article, or using any other suitable technique. In any event, one or more electrical signals representative of the user's input is received, and the identifier/article correlation is then stored in an electronic memory device (e.g., the memory device 32 of the ECU 22).

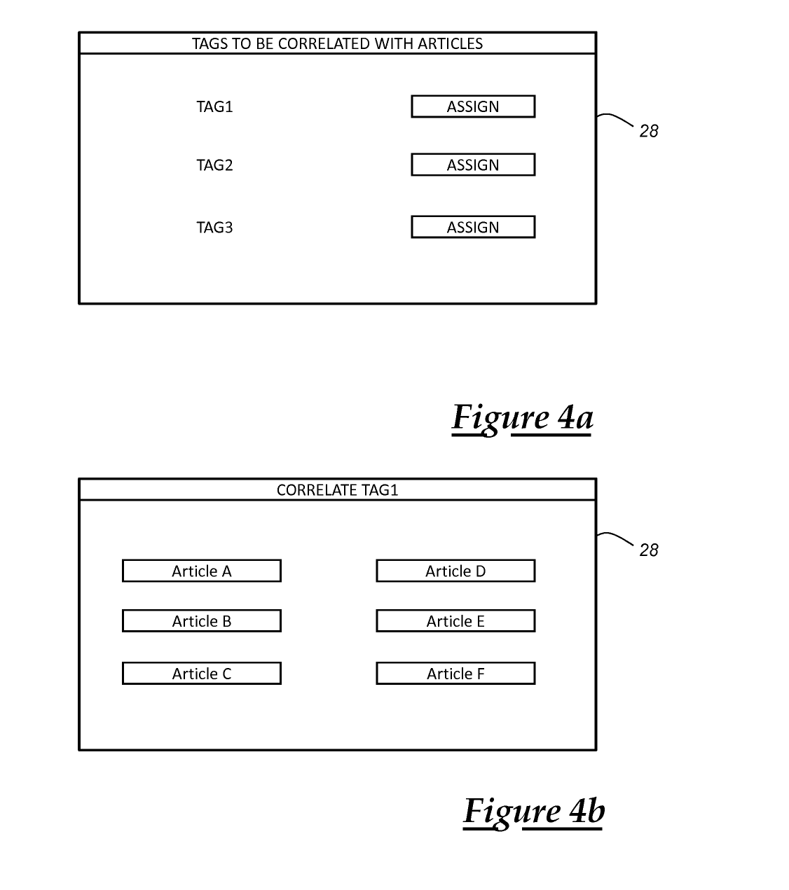

By way of example, FIGS. 4a and 4b illustrate one illustrative way in which step 108 may be performed. More specifically, and with reference to FIG. 4a, the identifiers of the tags that have not yet been correlated with articles may be listed on a user interface displayed on a user interface device 28 along with a user-selectable button labeled “ASSIGN” that when selected, allows the user to assign or correlate that particular tag with an article. Upon selecting the “ASSIGN” button, another user interface, such as, for example, that illustrated in FIG. 4b, may be displayed from which the user may correlate the tag with an article. In the embodiment illustrated in FIG. 4b, selectable text boxes with the names of different articles may be displayed from which the user may make a selection. In response to the selection of one of the boxes, the ECU 22 may correlate the tag with the article corresponding to the selected box. It will be appreciated that while one illustrative way of correlating a tag with an article has been provided, the present system and method are not intended to be limited to any particular way(s) of doing so, and thus, any number of suitable ways may be used.

In an embodiment, steps 106 and 108, both of which may be optional, may be performed by the ECU 22 of the inventory system 12 alone or in combination with one or more other components of system 12 (e.g., user interface device(s) 28).

Whether or not method 100 includes one or both of steps 106 and 108, in an embodiment, method 100 may comprise a step 110 of detecting the existence of one or more predetermined conditions related to or associated with initiating operation of the vehicle 10. Any number of conditions may be evaluated and possibly detected in step 110, including, but not limited to, one or more of those described below.

One such condition relates to the occupancy of the vehicle, and more particularly, comprises the vehicle being occupied by a particular occupant (which may or may not be the driver). This condition may be detected in a number of ways. One way, though certainly not the only way, is in response to a user input identifying an occupant of the vehicle. More specifically, in at least some embodiments, the inventory system 12 may be configured to prompt the occupant to provide his/her identity using, for example, a user interface device 28 of the system 12. This may include typing in a name using an actual or virtual keyboard or keypad, selecting a name from a list, and/or providing a name using audible commands, to cite a few possibilities. In other embodiments, the condition may be detected in response to information received by the inventory system 12 from other vehicle systems or components (e.g., a body control module, the telematics unit 16, one or more sensor(s) 18, etc.) and without any input on the part of a user. This may include, for example, and without limitation: the selection of a memory seat setting that corresponds to a particular individual; the detection of a particular key fob being present (i.e., a key fob assigned to a particular individual); the pairing of a particular person's smart phone or other electronic device with, for example, an infotainment system or the telematics unit 16 of the vehicle 10; a particular seat being occupied (e.g., a rear seat that is always occupied by a particular person (e.g., a VIP (in the case of a limousine or other chauffeured vehicle, for example), a seat at which a child/baby seat is installed, etc.)). In any event, the inventory system 12 may be configured to utilize the information it receives by comparing it with occupancy-related information stored in a memory device of the system 12 (e.g., the memory device 30 of the ECU 22) and when a match is found, it can be determined that the vehicle is occupied by a particular occupant, and thus, that the condition exists or is met.

Another condition that may be evaluated and detected in step 110 comprises the route being travelled by the vehicle 10 being a particular route. One way in which this condition may be detected is in response to a user input identifying the route. More particularly, in at least some embodiments, the inventory system 12 may be configured to prompt a user to provide the route or destination information using, for example, a user interface device 28 of the system 12. This may include typing in the route or destination using an actual or virtual keyboard or keypad, selecting the route or destination from a list of possible routes/destinations, and/or providing the route or destination using audible commands, to cite a few possibilities. In other embodiments, the condition may be detected in response to information received by the inventory system 12 from other vehicle systems or components and without any input on the part of a user. For example, the inventory system 12 may receive information from the navigation unit 14 or the telematics unit 16 indicative of, or that may be used to derive, the route being travelled by the vehicle. The inventory system 12 may be configured to utilize this information by comparing it with route information stored in a memory device of the system 12 (e.g., the memory device 30 of the ECU 22) and when a match is found, it can be determined that the vehicle is travelling a particular route, and thus, that the condition exists or is met.

Yet another condition that may be evaluated and detected in step 110 comprises a current and/or an expected weather condition in the vicinity of the vehicle (e.g., in the vicinity of the current and/or a future location of the vehicle) being a particular weather condition (e.g., rain, snow, wind, the temperature being above or below a particular threshold, etc.). One way this condition may be detected is in response to a user input identifying the current or expected weather condition(s). More particularly, in at least some embodiments, the inventory system 12 may be configured to prompt a user to provide information relating to the current and/or expected weather condition(s) using, for example, a user interface device 28 of the system 12. This may include typing in the current and/or expected weather condition(s) using an actual or virtual keyboard or keypad, selecting the current and/or expected weather condition(s) from a list, and/or providing the current and/or expected weather condition(s) using audible commands, to cite a few possibilities. In other embodiments, the current and/or expect weather condition(s) may be detected in response to information received by the inventory system 12 from other vehicle systems or components and without any input on the part of a user. For example, the inventory system 12 may receive information from the telematics unit 16, one or more of the sensors 18 (e.g., rain sensor(s), temperature sensor(s), etc.), or other suitable components that is indicative of, or that may be used to derive, the current or expected weather condition(s). The inventory system 12 may be configured to utilize this information by comparing it with predetermined weather condition(s) stored in a memory device of the system 12 (e.g., the memory device 30 of the ECU 22) and when a match is found, it can be determined that the weather-related condition exists or is met.

Other conditions that may be evaluated and possibly detected in step 110 may include the current time of day being a particular time of day (e.g., morning, afternoon, evening, etc., or a specific time), the current day of the week being a particular day of the week (e.g., Monday, Tuesday, etc.), and/or the current date being a particular date (e.g., the date being a particular day, month, year). Each of these conditions may be detected in a number of ways. One way is in response to a user input identifying the current time, day of the week, and/or date. More particularly, in at least some embodiments, the inventory system 12 may be configured to prompt a user to provide information relating to the current time, day, or date using, for example, a user interface device 28 of the system 12. This may include typing in the information using an actual or virtual keyboard or keypad, selecting relevant information from a list, and/or providing the information using audible commands, to cite a few possibilities. In other embodiments, the time/day/date conditions may be detected by the inventory system 12 itself or in response to information received by the inventory system 12 from other vehicle systems or components without any input on the part of a user. For example, the inventory system 12, and the ECU 22 thereof, in particular, may include clock or calendar functionality that allows for the current time of day, day of the week, and/or date to be determined. Alternatively, the inventory system 12 may receive time/day/date information from, for example, the telematics unit 16 or another vehicle component. In either instance, the inventory system 12 may be configured to utilize the time/day/date information by comparing it with predetermined time/day/date information stored in a memory device of the system 12 (e.g., the memory device 30 of the ECU 22) and when a match is found, it can be determined that the weather-related condition exists or is met.

While certain conditions have been described in detail above, it will be appreciated that conditions in addition to or in lieu of those described above may certainly be used as the present system and method are not limited to any particular condition(s). It will be further appreciated that while particular ways of detecting the conditions described above have been provided, the present system and method are not intended to be limited to that or those ways, but rather other suitable ways may also or alternatively be used. In an embodiment, step 110 is performed by the ECU 22 of the inventory system 12 either alone or in combination with one or more other components of the system 12, for example, the user interface device(s) 28.

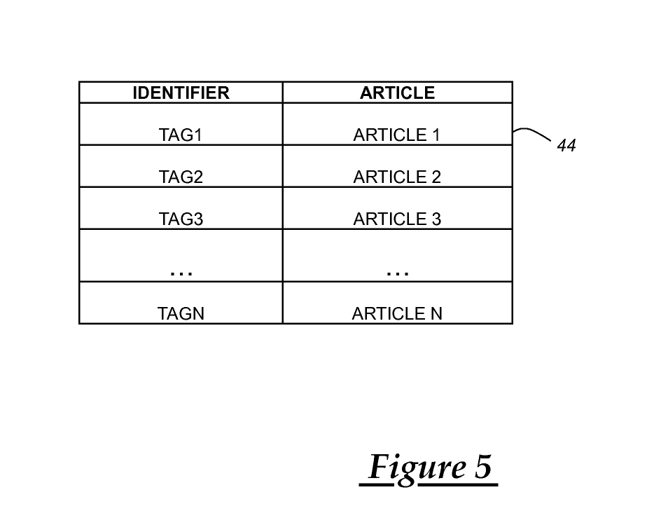

When it is determined in step 110 that a particular condition or combination of the conditions exist, method 100 may proceed to a step 112 of automatically accessing a list of articles expected to be present at the vehicle when the detected condition(s) exist. In an embodiment, this may comprise accessing the list from a memory device of the inventory system 12 (e.g., the memory device 32 of the ECU 22), and in at least some embodiments, may comprise selecting the list from a plurality of pre-established lists of articles based on the detected condition(s). More specifically, in an embodiment, step 110 may comprise looking up the detected existing conditions in a look-up table or other data structure that correlates condition(s) with pre-established list(s) of articles, and then selecting or accessing the list corresponding to the particular condition(s) detected in step 110. In either instance, the accessed list may be created or established based on, for example, a user-defined profile for each tag/article. This profile, which may be set for a given tag during step 108 or at another time using, for example, a user interface device 26, and which may be recorded and stored in a memory device of the system 12 (e.g., the memory device 30 of the ECU 22), will identify the condition(s) for which a notification should be generated for that particular tag/article, and then that tag/article will be added to the list(s) for that/those defined condition(s). In any event, for each article on or in the accessed list, the list may include, for example, the name of the article and the unique identifier (or some representation thereof) corresponding to the tag 26 that is associated with that article. By way of example, FIG. 5 depicts an illustrative list of articles 44 expected to be present when “Condition A” exists. As can be seen, the list 44 comprises the name of each article along with the unique identifier of the tag 26 with which the article is associated. In embodiment, step 112 is performed by the ECU 22 of the inventory system 12, and the processing device 32 thereof, in particular.

Following step 112, method 100 may include a step 114 of determining whether any of the articles on the accessed list are not present at (are absent from) the vehicle 10 based on the electrical signal(s) received from the electronic tag(s) 26 in step 104. As described above, each electrical signal received from a tag 26 in step 104 is representative of an identifier unique to that particular tag, and therefore, unique to the article associated therewith. Accordingly, in an embodiment, step 114 comprises comparing each of the received identifiers with the identifier(s) correlated with or corresponding to the article(s) on the accessed list. If it is determined that each of the identifiers correlated with the article(s) on the list match an identifier received from a tag 26, then it can be determined that all of the articles expected to be present at the vehicle are, in fact present, and method 100 may then loop back to a previous step (e.g., step 104 or, as shown in FIG. 3, step 110) or may terminate. If, however, one or more identifiers correlated with one or more respective article(s) on the list do not match an identifier received from a tag 26, then it can be determined that that or those article(s) are not present at (are absent from) the vehicle 10, and method 100 may proceed to a step 116 of causing one or more notifications indicating the absence of that or those articles to be generated. In an embodiment, step 114 may be performed by the ECU 22 of the inventory system 12, and the processing device 32 thereof, in particular.

In an embodiment, step 116 of causing one or more notifications indicating the absence of one or more articles to be generated comprises the system 12 itself generating and displaying the notification. More particularly, in an embodiment, the ECU 22 of the system 12 may be configured to generate the notification and cause it to be displayed on one of the user interface device(s) 28. In another embodiment, step 116 may comprise the inventory system 12 controlling, directly or indirectly, another component of the vehicle to generate and/or display the notification (e.g., the telematics unit 16, a speaker of the audio system of the vehicle, etc.) by generating a command and sending it to the other component that is configured to perform the required functionality. In any event, the notification may take a number of forms.

One example is an audible or auditory notification displayed or output at (e.g., inside) the vehicle 10. This may include, for example and without limitation, a verbal message (e.g., “you forgot your [name of article]”) displayed using a user interface device 28 (e.g., speaker) of the inventory system 12, or a speaker of another vehicle system.

Another example is a visual notification displayed at (e.g., inside) the vehicle 10. This may include, for example and without limitation, a visual or text-based message advising that one or more articles are absent (e.g., “you forgot [name of article]”), a list of absent article(s), and/or any other suitable visual notification(s) displayed on a suitable display device, for example, a user interface device 28 of the inventory system 12.

Yet another example is a message electronically communicated to a recipient advising of the absent article(s). This message may comprise an electronic mail message, a text message, or an automated recording advising that one or more articles are absent, and may be transmitted or communicated to a predetermined email address or telephone number registered with inventory system 12 or another component of the vehicle (e.g., the telematics unit 16). The electronic message may be transmitted over a suitable communication network by, for example, the inventory system 12, the telematics unit 16, or another suitable component.

Accordingly, it will be appreciated in view of the foregoing that any number of notifications may be caused to be generated in step 116, including, but not limited to, one or a combination of those described above, and therefore, the present system and method are not intended to be limited to any particular notification(s). It will be further appreciated that in an embodiment, step 116 may performed by the ECU 22 of the inventory system 12 alone or in combination with one or more other components of the system 12 or the vehicle 10.

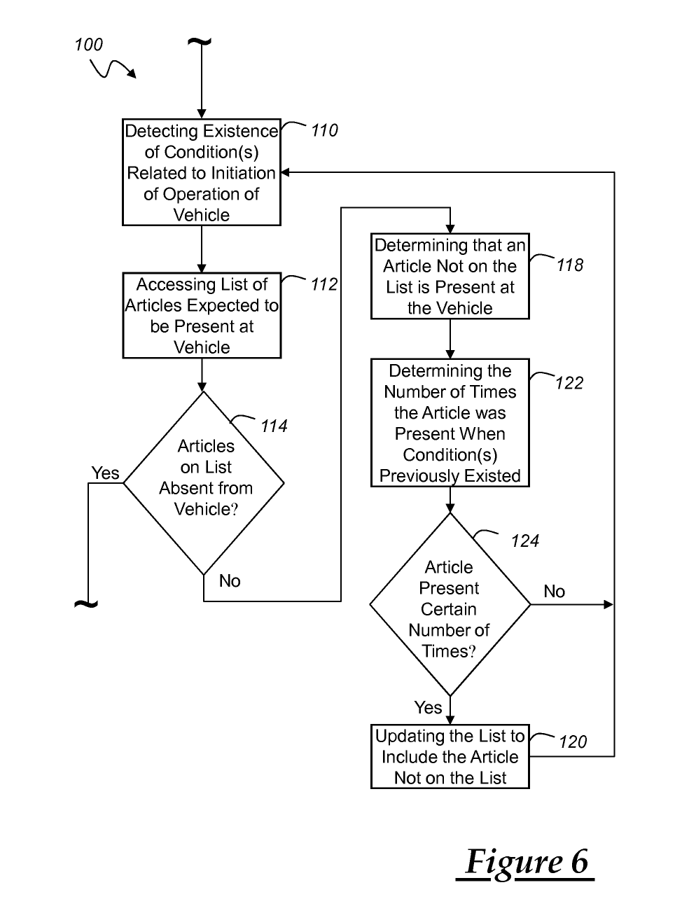

In addition to the steps described above, in at least some embodiments, method 100 may include one or more additional steps, some or all of which may be optional. For example, and with reference to FIG. 6, in an embodiment method 100 comprises a step 118 of determining that an article not on the list accessed in step 114 is nonetheless present at the vehicle 10 based on electrical signal(s) received in step 104 from an electronic tag 26 associated with that article. In an embodiment, step 118 may comprise comparing each identifier received in step 104, and determining that an article not on the list is present when a received identifier does not match an identifier on the list. In such an embodiment, method 100 may further include a step 120 of updating, either automatically or in response to a user input, the accessed list to include that article (and its corresponding identifier).

In at some embodiments wherein method 100 includes step 120, method 100 may further include one or more steps prior to updating the accessed list in step 120. For example, method 100 may include an intermediate step 122 of determining how many times the subject article was present at the vehicle when the predetermined condition(s) was/were previously detected. Accordingly, in an embodiment, each time an article not on the accessed list is determined to be present when the relevant condition(s) exist, that occurrence is recorded in a memory device (e.g., the memory device 30 of the inventory system ECU 22). If it is determined in a step 124 that the article was present at least a certain number of times (e.g., the number of times exceeds (or, in an embodiment, meets or exceeds, a predetermined threshold), then method 100 may proceed to step 120. If, however, it is determined that the article was not present at least a certain number of times, method 100 does not proceed to step 120 but rather may move to a different step of the method (e.g., step 114) or method 100 may terminate.

In any event, in an embodiment wherein method 100 does not include steps 106 and 108 described above, method 100 may further include a step (not shown) of correlating the received identifier with an article prior to updating the list in step 120. This may be done in the same or similar technique as that described above with respect to steps 106 and 108, which will not be repeated but rather is incorporated here by reference.

Whether or not method 100 includes one or more of steps 118-122, in an embodiment such as that illustrated in FIG. 3 wherein steps 106 and 108 are included, method 100 may further include a step 125 of adding the article correlated with a received identifier in step 108 to one or more lists of articles expected to be present at the vehicle 10 when one or more corresponding conditions are exist. Step 125 may be performed in a number of ways. One way is that a user may be prompted via a user interface device 28 of the inventory system 12 to select those condition(s) for which it would be expected that the article would be present at the vehicle 10. This may include, for example, displaying a graphical and/or text-based user interface containing one or more user-selectable fields (e.g., radio buttons, icons, drop down menu(s), etc.) representing each possible condition/combination of conditions, and/or one or more user-inputtable fields. The user may use the displayed field(s) to select or otherwise denote the desired condition(s), and then the article (along with its corresponding identifier) may be added to the list(s) corresponding to the desired condition(s). Another way in which step 125 may be performed is by automatically adding the article correlated with the received identifier to the list corresponding to the conditions detected, for example, in step 110 (i.e., the article(s) would be added to the list accessed in step 114, and thus, step 125 would be performed following step 110). Accordingly, the article (and its corresponding identifier) may be automatically added to the appropriate list(s) in response to the detected condition(s). In either instance, step 125 may be performed by the ECU 22 of the inventory system 12, and in certain implementations, the ECU 22 in combination with one or more user interface device(s) 28 of the system 12.

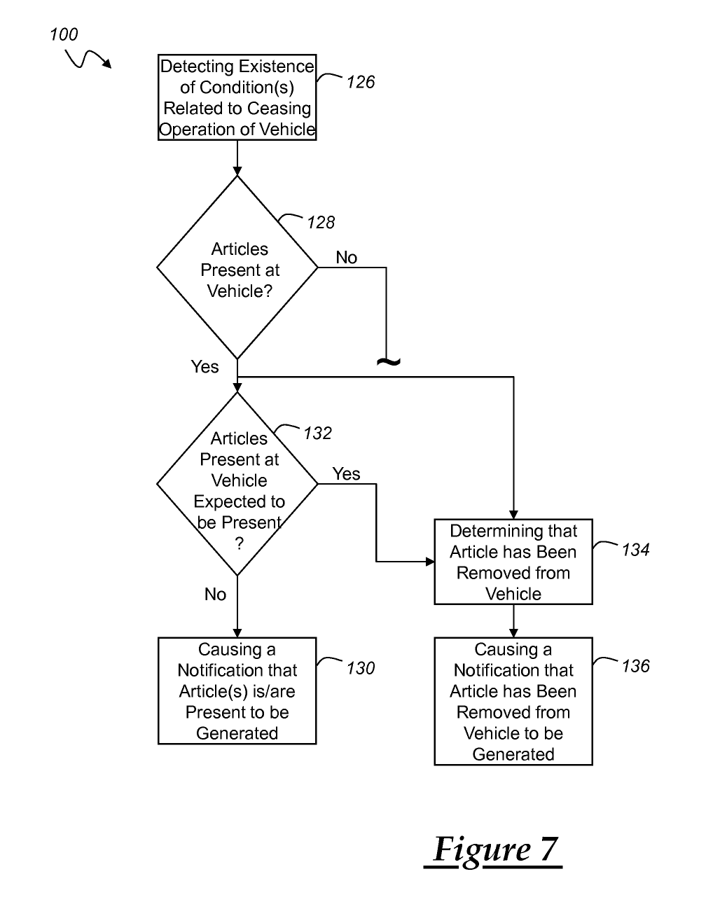

Whether or not method 100 includes some or all of steps 102-125, in an embodiment, method 100 may include a step 126 of detecting the existence of one or more predetermined conditions associated with ceasing operation of the vehicle. In an illustrative embodiment, one condition that may be evaluated and possibly detected in step 126 is that an occupant of the vehicle (e.g., the driver) has exited the vehicle; though it will be appreciated that other additional or alternative conditions may certainly be evaluated and possibly detected. In an embodiment wherein method 100 includes, for example, some or all of steps 110-116, step 126 may be performed after that or those steps. Otherwise, step 126 may be performed after one or more of steps 102-108, or, as illustrated in FIG. 7, may comprise the first step of method 100.

Detecting that an occupant has exited the vehicle 10 may be performed in a number of ways. One way is by determining or detecting the occurrence of one or more predetermined events. Depending on the implementation, the one or more predetermined events may comprise one or a combination of some or all of the following: the vehicle engine being turned off; the vehicle engine being turned off and a predetermined period of time elapsing without it being restarted; the vehicle doors being locked; a smart key or key fob being removed from the vehicle and/or being moved more than a predetermined distance from the vehicle; sensing by various vehicle electronics (e.g., sensor(s) 18) that the occupant has exited the vehicle (e.g., via reading from one or more sensors 18 in one or more seats of the vehicle or as otherwise known in the art); and/or sensing that the occupant has left the vehicle and a predetermined period of time has elapsed without the occupant re-entering the vehicle, to cite a few possibilities. Accordingly, it will be appreciated that the present system and method are not limited to the use of any particular event(s) for the purpose of performing step 126; rather, any number or combination of events may be used.

Step 126 may be performed by the ECU 22 of the inventory system 12, and in at least some embodiments, the ECU 22 in combination or conjunction with one or more other components or systems of the vehicle 10. More particularly, in an embodiment, the ECU 22 may be configured to perform step 126 based on information received from one or more other components or systems of the vehicle, for example, one or more of sensors 18, the VCU 20, or other systems, components, or modules of the vehicle (e.g., a body control module, an electronic access and authorization module, etc.). Additionally, in an instance wherein information is received by the ECU 22, the information may be transmitted or communicated to the ECU automatically upon the information being obtained or acquired by the system/module providing the information, continuously or periodically in accordance with an established reporting scheme, in response to a query or request received from the ECU 22, or in some other suitable manner. Finally, in an instance wherein the predetermined event(s) includes a temporal component such as a predetermined amount of time having elapsed since the occurrence of a particular event, the ECU 22 may include a timer means to determine if and when the predetermined amount of time has elapsed.

In any event, following step 126, method 100 may move to a step 128 of determining whether any articles associated with the tag(s) 26 of the inventory system 12 are present at the vehicle, and thus, have been left in the vehicle. In an embodiment, step 128 comprises receiving one or more electrical signals from each of one or more tags 26 present at the vehicle. If no signals are received in step 128, it can be determined that no articles are present at the vehicle, and method 100 may loop back to a previous step or may terminate. If, on the other hand, one or more signals are received, it can be determined that the articles associated with the tag(s) 26 from which the signal(s) was/were received are present at the vehicle, and thus, may be been inadvertently left behind when the occupant exited the vehicle. Using the unique identifiers of the tags 26 represented by the received signals, the identity of the articles present at the vehicle can be determined, and method 100 may proceed to a step 130 of causing a notification indicating the presence of the article(s) at the vehicle to be generated. In an embodiment, step 128 is performed by the ECU 22 of the inventory system 12.

In an embodiment, step 130 of causing a notification indicating the presence of an article at the vehicle to be generated comprises the system 12 itself generating and displaying the notification. More particularly, in an embodiment, the ECU 22 of the system 12 may be configured to generate the notification and cause it to be displayed on one of the user interface device(s) 28. In another embodiment, step 130 may comprise the inventory system 12 controlling, directly or indirectly, another component of the vehicle to generate and/or display the notification (e.g., the telematics unit 16, a body control module, speaker of the audio system of the vehicle, the vehicle horn, some or all of the vehicle lights, etc.) by generating a command and sending it to the other component that is configured to perform the required functionality. In any event, the notification may take a number of forms.

One example is an audible or auditory notification that may be displayed or output inside and/or outside of the vehicle passenger compartment. This may include, for example and without limitation, the notifications described above with respect to step 116, as well as other suitable notifications (e.g., a distinct combination of sounds, for example, the honking of the horn and/or causing an alarm system of the vehicle to beep a certain number of times and/or for a certain length of time, etc.). Another notification is a visual notification that may be displayed inside and/or outside of the vehicle passenger compartment. This may include, for example and without limitation, the notifications described above with respect to step 116, as well as other suitable notifications (e.g., a sequence of flashes of one or more lights of the vehicle, one or more lights turning on and remaining on for at least a certain amount time, etc.). Another notification may be a message electronically communicated to a recipient advising of the absent article(s). This may include, for example and without limitation, an electronic message such as that described above with respect to step 116 (the description of which will not be repeated but rather is incorporate by reference here), as well as other suitable notifications.

Accordingly, it will be appreciated that any number of notifications may be caused to be generated in step 130, including, but not limited to, one or a combination of those described above, and therefore, the present system and method are not intended to be limited to any particular notification(s). It will be further appreciated that in an embodiment, step 130 may performed by the ECU 22 of the inventory system 12 either alone or in combination with one or more other components of the system 12 and/or the vehicle 10.

In at least some embodiments, method 100 may further include one or more intervening steps prior to performing step 130. For example, in an embodiment, method 100 may include a step 132 of determining that the article(s) determined to be present at the vehicle in step 128 is/are expected to be present even though the occupant has exited the vehicle. In an embodiment, if it is determined in step 132 that the article(s) is/are expected to be present, then method 100 does not proceed to step 130, but rather loops back to a previous step, moves, as shown in FIG. 7, to a subsequent step, or terminates. If, on the other hand, it is determined in step 132 that the article(s) is/are not expected to be present, method 100 may proceed to step 130 and a notification may be caused to be generated.

In an embodiment, step 132 comprises a number of substeps. For example, step 132 may include a substep of automatically accessing a list of articles expected to be present at the vehicle even though the vehicle occupant has exited the vehicle. In an embodiment, this may comprise accessing the list from a memory device of the inventory system 12 (e.g., the memory device 32 of the ECU 22), and in at least some embodiments, may comprise selecting the list from a plurality of pre-established lists using various criteria. Similar to the list illustrated in FIG. 5, for each article on or in the accessed list, the list may include, for example, the correlation between the name of the article and the unique identifier corresponding to the tag 26 associated therewith. Once the list is accessed, step 132 may move to a second substep of determining whether any of the articles on the accessed list are present at the vehicle 10 based on the electrical signal(s) received from the electronic tag(s) 26 in, for example, step 128. As described above, each electrical signal received from a tag 26 in step 128 is representative of an identifier unique to that particular tag, and therefore, unique to the article associated with the tag. Accordingly, in an embodiment, this substep of step 132 may comprise comparing each of the received identifiers with the identifier(s) corresponding to the article(s) on the accessed list. If it is determined that a received identifier matches one of the identifiers on the list, then it can be further determined that the article associated with that tag is expected to be present at the vehicle. Conversely, if it is determined that a received identifier does not match any of the identifiers on the list, then it can be further determined that the article associated with that tag is not expected to be present at the vehicle.

If it is determined in step 132 that one or more articles determined to be present at the vehicle are, in fact, expected to be present at the vehicle, method 100 may loop back to a previous step or may terminate. If, however, it is determined that one or more articles determined to be present at the vehicle are not expected to be present, method 100 may proceed to step 130 of causing one or more notifications indicating the presence of that or those articles to be generated. In an embodiment, step 132, may be performed by the ECU 22 of the inventory system 12, and the processing device 32 thereof, in particular.

Another intervening step (not shown) that may be performed prior to method 100 moving to step 130 comprises monitoring one or more parameters relating to one or more conditions or criteria that if met, cause method 100 to move to step 130. This may include, for example, monitoring the temperature in the vehicle and only moving to step 130 upon the temperature exceeding (or meeting or exceeding) a certain threshold temperature. Another parameter that may be monitored is the amount of time that has elapsed since the occupant exited the vehicle and only moving to step 130 upon the amount of elapsed time exceeding (or meeting or exceeding) a certain threshold. It will be appreciated that while certain parameters/criteria have been described, the present method is not limited to the monitoring or evaluation of any particular parameter(s)/criteria/condition(s). In an embodiment, this step may be performed by the ECU 22 of the inventory system 12, and the processing device 32 thereof, in particular, and in certain instances, in conjunction with information received from other components of the vehicle (e.g., sensor(s) 18, telematics unit 16, etc.).

In addition to the above, method 100 may further include one or more steps that may be performed following one or more of steps 128, 130, and/or 132. More particularly, in an embodiment, method 100 may include a step 134 of determining that an article previously determined to be present at the vehicle in step 128 has been removed from the vehicle, and a step 136 of causing a notification indicating the removal of the article to be generated. In at least some instances, step 136 is intended to provide notification that an article has possibly been stolen or otherwise removed from the vehicle without authorization.

In an embodiment, step 134 comprises continuously or periodically checking on the status of the article(s) determined to be in the vehicle by monitoring electrical signals received from the tag(s) 26 associated therewith. When it is determined that electrical signals are no longer being received from the tag 26 associated with a particular article, or at least that an electrical signal from a particular tag has not been received for a predetermined period of time, it can be determined that the article has been removed from the vehicle.

If it is determined in step 134 that an article has been removed from the vehicle, method 100 may proceed to step 136 of causing a notification indicating the removal of the article to be generated. In an embodiment, step 136 comprises the system 12 itself generating and displaying the notification. More particularly, in an embodiment, the ECU 22 of the system 12 may be configured to generate the notification and cause it to be displayed on one of the user interface device(s) 28. In another embodiment, step 130 may comprise the inventory system 12 controlling, directly or indirectly, another component of the vehicle to generate and/or display the notification (e.g., the telematics unit 16, a body control module, speaker of the audio system of the vehicle, the vehicle horn, some or all of the vehicle lights, etc.) by generating a command and sending it to the other component that is configured to perform the required functionality. In any event, the notification may take a number of forms, including, but not limited to, one or more of those described above with respect to steps 116 and 130, the description of which will not be repeated, but rather is incorporated here by reference.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of operating an inventory system of a vehicle having an electronic control unit, a wireless receiver, and one or more electronic tags, comprising:
detecting the existence of one or more predetermined conditions associated with initiating the operation of the vehicle;
automatically accessing from an electronic memory device, a list of articles expected to be present at the vehicle when the detected condition(s) exist, wherein the list of articles is selected from a plurality of pre-established lists of articles based on the detected condition(s);
receiving an electrical signal from each electronic tag associated with an article that is present in the vehicle;
determining whether any of the articles on the accessed list are not present at the vehicle based on the electrical signal(s) received from the electronic tag(s);
when it is determined that one or more articles are not present at the vehicle, causing a notification indicating the absence of that or those articles to be generated;
determining that an article not on the accessed list is present at the vehicle based on an electrical signal received from the electronic tag associated with that article; and
automatically updating the accessed list to include that article.

2. The method of claim 1, wherein the detecting step comprises detecting the existence of one or more predetermined conditions at least in part in response to information received from one or more vehicle components and without any input from a vehicle user.

3. The method of claim 1, wherein the one or more predetermined conditions comprises the vehicle being occupied by a particular occupant, and further wherein the detecting step comprises detecting that the vehicle is occupied by the particular occupant, and the accessing step comprises automatically selecting the list of articles from the plurality of lists of articles that corresponds to the particular occupant.

4. The method of claim 1, wherein the one or more predetermined conditions comprises the route being travelled by the vehicle being a particular route, and further wherein the detecting step comprises detecting that the route being travelled by the vehicle is the particular route, and the accessing step comprises automatically selecting the list of articles from the plurality of lists of articles that corresponds to the particular route.

5. The method of claim 1, wherein the one or more predetermined conditions comprises at least one of a current or expected weather condition in the vicinity of the vehicle being a particular weather condition, and further wherein the detecting step comprises detecting that at least one of a current or expected weather condition in the vicinity of the vehicle is the particular weather condition, and the accessing step comprises automatically selecting the list of articles from the plurality of lists of articles that corresponds to the particular weather condition.

6. The method of claim 1, wherein the one or more predetermined conditions comprises at least one of the current time of day being a particular time of day or the current day of the week being a particular day of the week, and further wherein the detecting step comprises at least one of detecting that the current time of day is the particular time of time or the current day of the week is the particular day of the week, and the accessing step comprises automatically selecting the list of articles from the plurality of lists of articles that corresponds to at least one of the particular time of day or the particular day of the week.

7. The method of claim 1, wherein each electrical signal received in the receiving step is representative of an identifier unique to the electronic tag from which that electric signal was received, and wherein the determining step comprises:
comparing the received identifier(s) with identifier(s) correlated with the article(s) on the accessed list; and
when an identifier correlated with an article on the list does not match one of the received identifiers, determining that the article is not present at the vehicle.

8. The method of claim 1, wherein the notification comprises at least one of:
an auditory notification displayed at the vehicle;
a visual notification displayed at the vehicle; or
a message electronically communicated to a designated recipient.

9. (canceled)

10. The method of claim 1, further comprising:
automatically determining how many times the article not on the accessed list was present at the vehicle when the predetermined condition(s) was/were previously detected; and
automatically updating the accessed list to include the article only when the number of times the article was present at the vehicle exceeds a predetermined threshold.

11-20. (canceled)

21. The method of claim 1, further comprising:
detecting that an occupant has exited the vehicle;
following the detection that the occupant has exited the vehicle, determining that an article is present at the vehicle in response to the receipt of an electrical signal from an electronic tag associated with that article; and
causing a notification indicating the presence of the article at the vehicle to be generated.

22. The method of claim 21, further comprising determining whether the article present at the vehicle is expected to be present at the vehicle, and wherein a notification indicating the presence of the article is caused to be generated only when the article is not expected to be present at the vehicle.

23. The method of claim 22, wherein determining whether the article is expected to be present at the vehicle comprises:
comparing the article to a pre-established list of articles expected to be present at the vehicle; and
determining that the article is expected to be present at the vehicle when it matches one of the articles on the list.

24. The method of claim 21, wherein the notification indicating the presence of the article at the vehicle comprises at least one of:
an auditory notification displayed at the vehicle;
a visual notification displayed at the vehicle; or
a message electronically communicated to a recipient.

25. The method of claim 21, wherein following the causing of a notification indicating the presence of the article at the vehicle to be generated, the method further comprises:
determining that the article previously determined to be present at the vehicle has been removed from the vehicle; and
causing a notification indicating the removal of the article to be generated.

26. An inventory system of a vehicle, comprising:
an electronic processing device;
an electronic memory device electrically coupled to the electronic processing device and having instructions stored therein,
wherein the electronic processing device is configured to access the memory electronic device and execute the instructions stored therein such that electronic processing device is configured to:
detect the existence of one or more predetermined conditions associated with initiating the operation of the vehicle;
automatically access from the electronic memory device, a list of articles expected to be present at the vehicle when the detected condition(s) exist, wherein the list of articles is selected from a plurality of pre-established lists of articles based on the detected condition(s);
receive an electrical signal from each electronic tag associated with an article that is present in the vehicle;
determine whether any of the articles on the accessed list are not present at the vehicle based on the electrical signal(s) received from the electronic tag(s);
when it is determined that one or more articles are not present at the vehicle, cause a notification indicating the absence of that or those articles to be generated;
determine that an article not on the accessed list is present at the vehicle based on an electrical signal received from the electronic tag associated with that article; and
automatically update the accessed list to include that article.

27. The system of claim 26, wherein each received electrical signal is representative of an identifier unique to the electronic tag from which that electric signal was received, and further wherein the electronic processing device is configured to determine whether any of the articles on the accessed list are not present at the vehicle by:
comparing the received identifier(s) with the identifier(s) correlated with the article(s) on the accessed list; and
when an identifier correlated with an article on the list does not match one of the received identifiers, determining that the article is not present at the vehicle.

28. The system of claim 26, wherein the electronic processing device is further configured to:
automatically determine how many times the article not on the accessed list was present at the vehicle when the predetermined condition(s) was/were previously detected; and
automatically update the accessed list to include the article only when the number of times the article was present at the vehicle exceeds a predetermined threshold.

29. The system of claim 26, wherein the electronic processing device is further configured to:
detect that an occupant has exited the vehicle;
following the detection that the occupant has exited the vehicle, determine that an article is present at the vehicle in response to the receipt of an electrical signal from an electronic tag associated with that article; and
cause a notification indicating the presence of the article at the vehicle to be generated.

30. The system of claim 29, wherein the electronic processing device is configured to determine whether the article present at the vehicle is expected to be present at the vehicle, and to cause the notification indicating the presence of the article at the vehicle to be generated only when the article is not expected to be present at the vehicle.

31. The system of claim 29, wherein following the causing of a notification indicating the presence of the article at the vehicle to be generated, the electronic processing device is configured to:
determine that the article previously determined to be present at the vehicle has been removed from the vehicle; and
cause a notification indicating the removal of the article to be generated.
